(19) United States
(12) Patent Application Publication
(10) Pub. No.: US 2013/0027974 A1
(43) Pub. Date: Jan. 31, 2013

(54) ELECTRONIC DEVICE WITH LIGHT-GUIDE STRUCTURE

(71) Applicant: FU-KUO HUANG, Tu-Cheng (TW)

(72) Inventor: FU-KUO HUANG, Tu-Cheng (TW)

(73) Assignee: HON HAI PRECISION INDUSTRY CO., LTD., Tu-Cheng (TW)

(21) Appl. No.: 13/441,071

(22) Filed: Apr. 6, 2012

(30) Foreign Application Priority Data
Jul. 29, 2011 (TW) 100126918

(51) Int. Cl. F21V 7/04; F21V 8/00

(52) U.S. Cl. 362/609

(57) ABSTRACT

An electronic device includes an enclosure and a light-guide structure. The enclosure includes a bottom plate and a side plate. A circuit board is attached to the bottom plate. The light-guide structure includes a light source, an indicator-lamp head, and a light-guide post located between the light source and the indicator-lamp head. The light source is electronically connected to the circuit board to emit a plurality of parallel lights substantially perpendicular to the circuit board. The indicator-lamp head is attached to the side plate. The light-guide post includes a curve surface adjacent to the indicator-lamp head. The curve surface includes an arcuate convex surface towards the indicator-lamp head, and the arcuate convex surface is adapted to reflect the plurality of parallel lights and transmits the plurality of parallel lights into a plurality of emanative lights towards the indicator-lamp head.

### CROSS-REFERENCE TO RELATED APPLICATIONS

The present application is related to co-pending application entitled, “ELECTRONIC DEVICE WITH LIGHT-GUIDE STRUCTURE”, filed on ______, application Ser. No. ______, (Atty. Docket No. US40509).

### BACKGROUND

1. Technical Field

The present disclosure relates to electronic devices, and more particularly to an electronic device with a light-guide structure.

2. Description of Related Art

Indicator lamps are often used in electronic device, such as a computer, or a testing device. The electronic device may include a panel and a circuit board, and an indicator lamp is usually secured to an outside of the panel. A light source is electronically connected to the circuit board. The indicator lamp and the light source may be arranged in a straight line substantially perpendicular to the circuit board, and light beams from the light source can be directly transmitted to the indicator lamp. However, when the indicator lamp is attached to a different location, and the light beams from the light source cannot be completely transmitted to the indicator lamp. Thus, a brightness of the indicator lamp is too weak such that the indicator lamp may be nearly invisible. Therefore, an electronic device with an improved light-guide structure may be desired within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device in accordance with an embodiment.

FIG. 2 is assembled view of FIG. 1

FIG. 3 is a left view of the light-guide structure of the electronic device in accordance with the embodiment of FIG. 1.

FIG. 4 is a right view of the light-guide structure of FIG. 1.

FIG. 5 is a top view of the light-guide structure of FIG. 1.

FIG. 6 is an exploded, isometric view of an electronic device in accordance with another embodiment.

FIG. 7 is an assembled view of FIG. 6.

FIG. 8 is a left view of the light-guide structure of FIG. 6.

FIG. 9 is a top view of the light-guide structure of FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

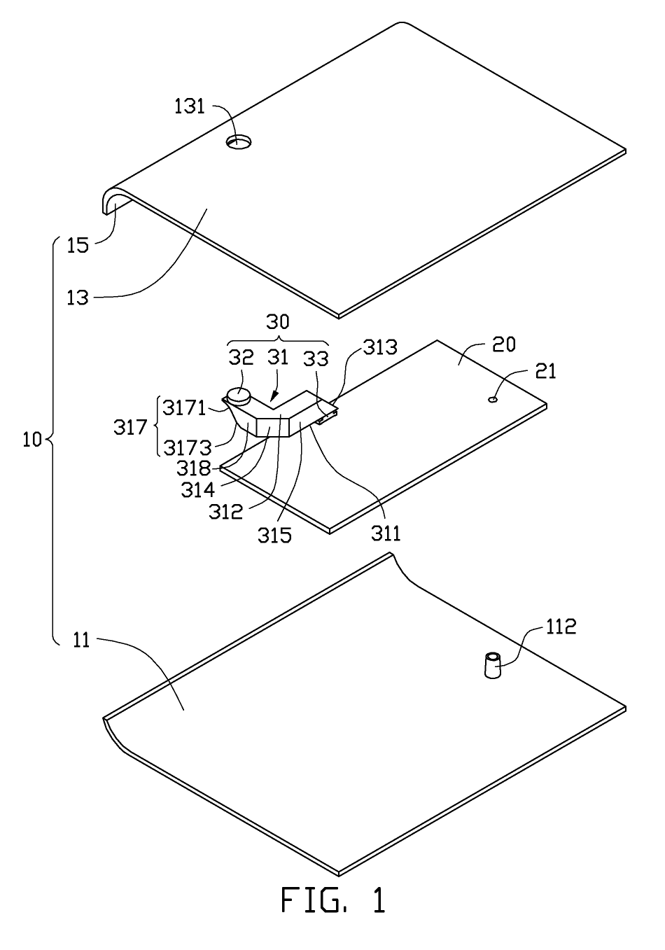

Referring to FIGS. 1 to 3, an electronic device in accordance with an embodiment, includes an enclosure 10, a circuit board 20, and a light-guide structure 30. The light-guide structure 30 is attached to the circuit board 20, and the circuit board 20 and the light-guide structure 30 are together received in the enclosure 10.

The enclosure 10 includes a bottom plate 11, a top plate 13, and a side plate 15 connected to the bottom plate 11 and the top plate 13. A positioning post 112 is located on the bottom plate 11 for positioning the circuit board 20. The top plate 13 defines a through hole 131. The circuit board 20 defines a positioning hole 21 corresponding to the positioning post 112. In one embodiment, the bottom plate 11 is substantially parallel to the top plate 13, and the side plate 15 is arcuate.

The light-guide structure 30 includes a light-guide post 31, an indicator-lamp head 32, and a light source 33. In one embodiment, the indicator-lamp head 32 can be round or a rectangle, and the light source 33 can be a LED or a power supply.

The light-guide post 31 includes a bottom surface 311, a top surface 312, a first reflecting surface 313, a second reflecting surface 314, a first connecting surface 315, a curve surface 317, and a second connecting surface 318. The first connecting surface 315 is connected to the first reflecting surface 313 and the second reflecting surface 314, and the second connecting surface 318 is connected to the second reflecting surface 314 and the curve surface 317. In one embodiment, an acute angle is defined between the first reflecting surface 313 and the bottom surface 311. An obtuse angle is defined between the second reflecting surface 314 and the first connecting surface 315, and an obtuse angle is defined between the second reflecting surface 314 and the second connecting surface 318.

The curve surface 317 includes an arcuate convex surface 3171 and an arcuate concave surface 3173 connected to the arcuate convex surface 3171. The arcuate convex surface 3171 is towards the indicator-lamp head 32. The indicator-lamp head 32 is above the top surface 312 and adjacent to the arcuate convex surface 3171. The light source 33 is below the bottom plate 311 and adjacent to the first reflecting surface 313. In one embodiment, an angle between the first reflecting surface 313 and the bottom plate 311 is about 45°, an angle between the second reflecting surface 314 and the first connecting surface 315 is about 135°, and the an angle between the second reflecting surface 314 and the second connecting surface 318 is about 135°.

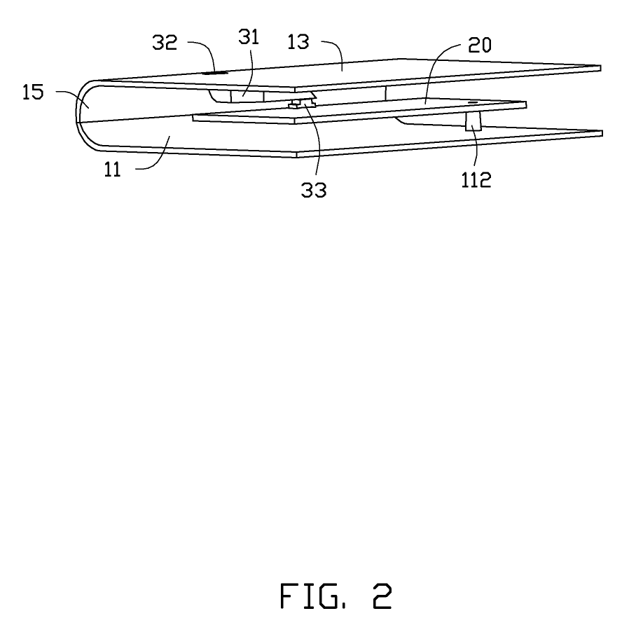

Referring to FIG. 2, in assembly, the side plate 15 is secured to the bottom plate 11 by jointing. The circuit board 20 is placed on the bottom plate 11, and the positioning post 112 is engaged in the positioning hole 21. The circuit board 20 is thus secured to the bottom plate 11. The light-guide structure 30 is located between the circuit board 20 and the top plate 13. The light source 33 is electronically connected to the circuit board 20. The indicator-lamp head 32 is received in the through hole 131. In one embodiment, the indicator-lamp head 32 and the light source 33 are arranged at a line that is not perpendicular to a plane of the circuit board 20.

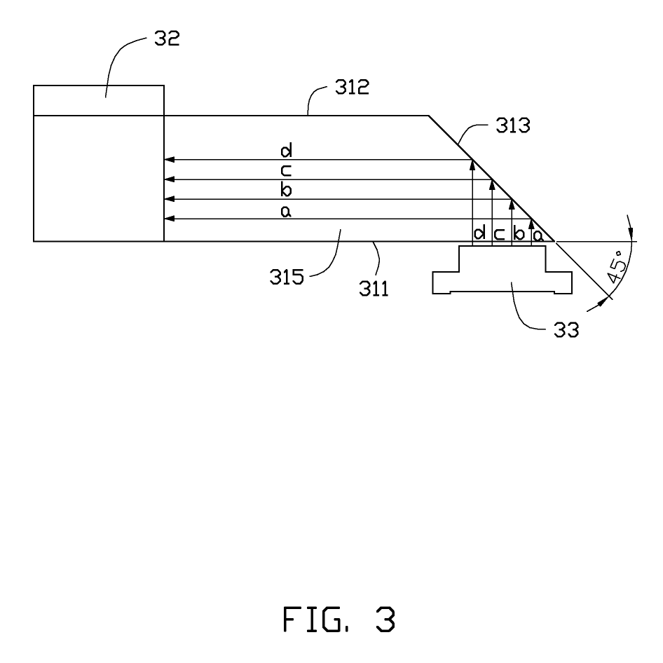

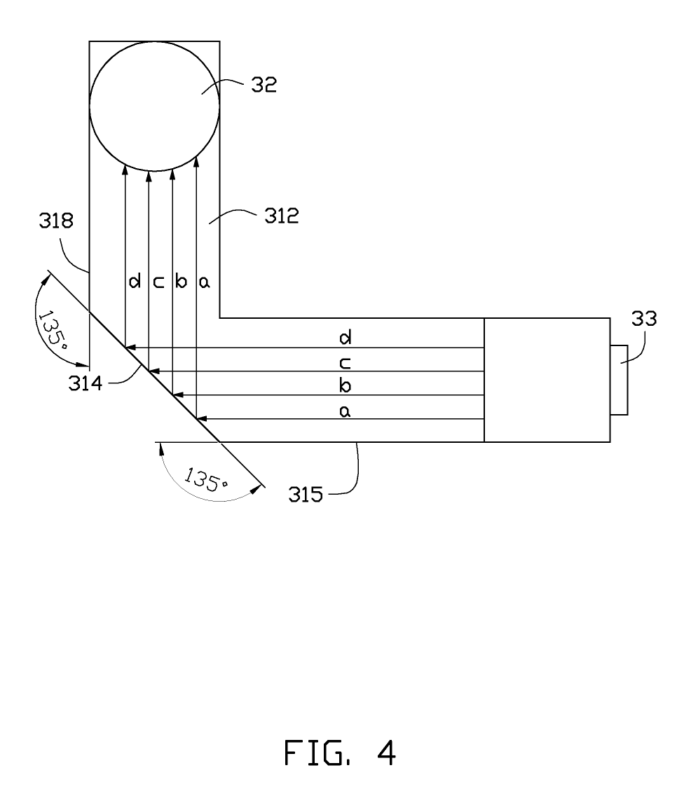

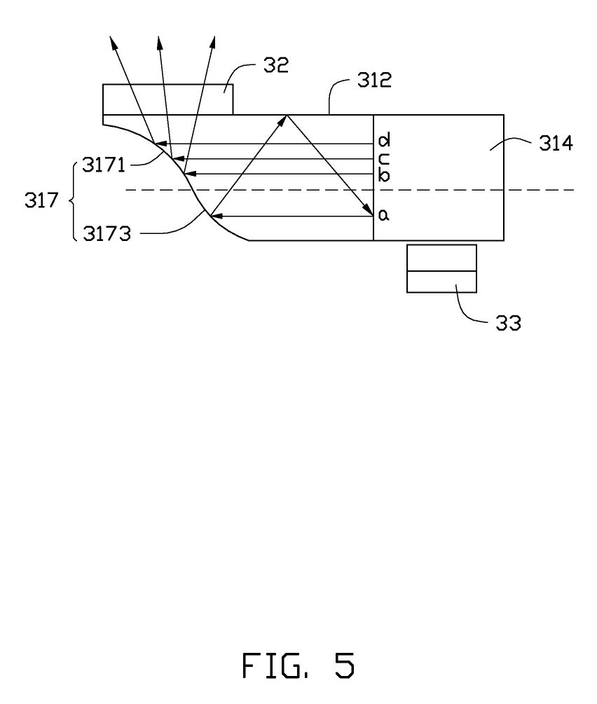

Referring to FIGS. 3-5, in use, a plurality of light beams 33 are emitted from the light source 33, and the plurality of light beams 33 are substantially perpendicular to the circuit board 20. The plurality of light beams 33 extend through the bottom surface 311 and emits to the first reflecting surface 313. For example, four light beams a, b, c, and d emit to the first reflecting surface 313. Because the angle between the first reflecting surface 313 and the bottom surface 311 is 45°, the four light beams a, b, c, and d can emit to the second reflecting surface 314 by the first reflecting surface 313 according to a reflection law of the light (see FIG. 4). Then, the four light beams a, b, c, and d can emit to the curve surface 317 by the second reflecting surface 314. When the four light beams a, b, c, and d are transmitted to the curve surface 317, the light beam a is transmitted to the arcuate concave surface 3173, and returned to the light source 33 by the second reflecting surface 314 and the first reflecting surface 313. The light beams b, c, and d are transmitted to the arcuate convex surface 3171, and then diffused to the indicator-lamp head 32.

Therefore, an uniform light can be shown by the indicator-lamp head 32. In one embodiment, the light beams b, c, and d are reflected three times with the first reflecting surface 313, the second reflecting surface 314 and the curve surface 317, and reached to the indicator-lamp head 32.

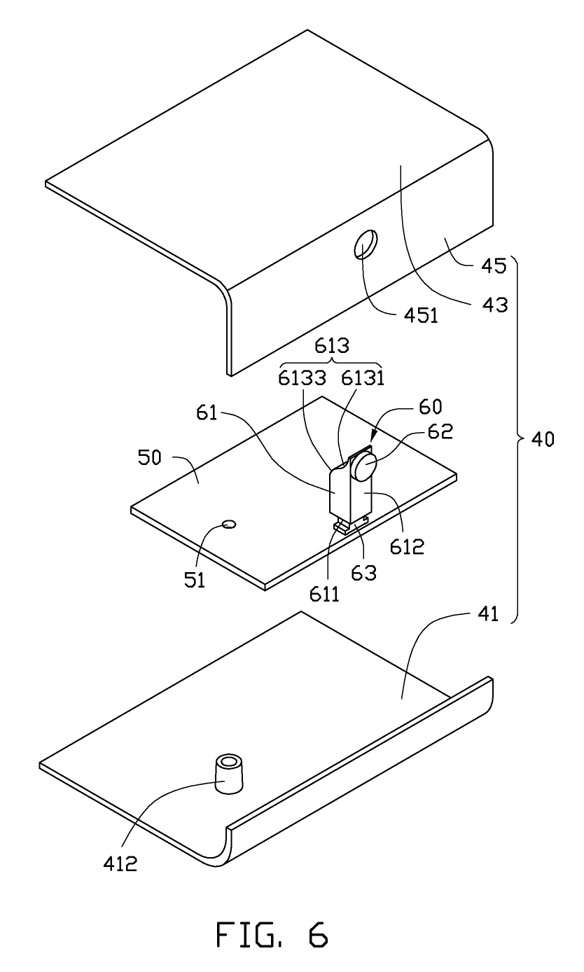

Referring to FIG. 6, an electronic device in accordance with another embodiment, includes an enclosure 40, a circuit board 50, and a light-guide structure 60. The light-guide structure 60 is attached to the circuit board 50, and the circuit board 50 and the light-guide structure 60 are together received in the enclosure 40.

The enclosure 40 includes a bottom plate 41, a top plate 43, and a side plate 45 connected to the bottom plate 41 and the top plate 43. A positioning post 412 is located on the bottom plate 41 for positioning the circuit board 50. The side plate 45 defines a through hole 451. The circuit board 50 defines a positioning hole 51 corresponding to the positioning post 412. In one embodiment, the bottom plate 41 is substantially parallel to the top plate 43, and the side plate 45 is arcuate.

The light-guide structure 60 includes a light-guide post 61, an indicator-lamp head 62, and a light source 63. In one embodiment, the indicator-lamp head 62 is a round or a rectangle, and the light source 63 can be a LED or a power supply.

The light-guide post 61 includes a bottom surface 611, a top surface 612, and a curve surface 613. The curve surface 613 includes an arcuate convex surface 6131 and an arcuate concave surface 6133 connected to the arcuate convex surface 3171. The arcuate convex surface 6131 is towards the indicator-lamp head 62. The indicator-lamp head 62 is adjacent to the arcuate convex surface 6131. The light source 63 is below the bottom plate 311.

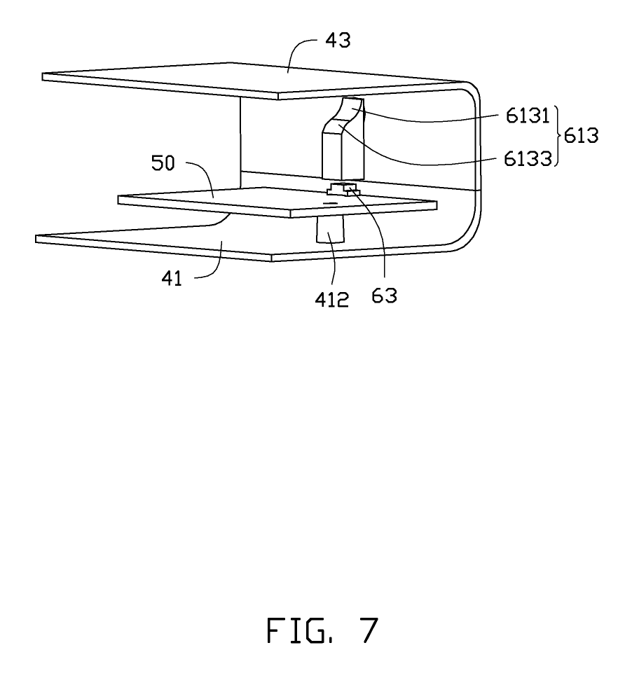

Referring to FIG. 7, in assembly, the side plate 45 is secured to the bottom plate 41 by jointing. The circuit board 50 is placed on the bottom plate 41, and the positioning post 412 is engaged in the positioning hole 51. The circuit board 50 is thus secured to the bottom plate 41. The light-guide structure 60 is located between the circuit board 50 and the top plate 43, and the light source 63 is electronically connected to the circuit board 50.

The indicator-lamp head 62 is received in the through hole 451. In one embodiment, the indicator-lamp head 62 and the light source 63 are arranged at a line that is not perpendicular to a plane of the circuit board 50.

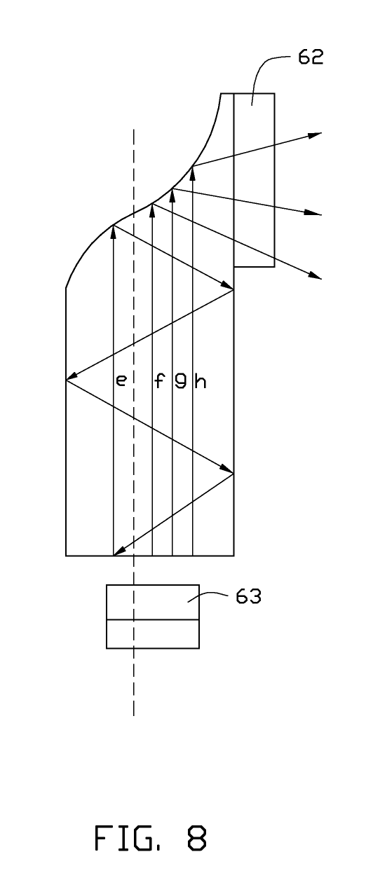

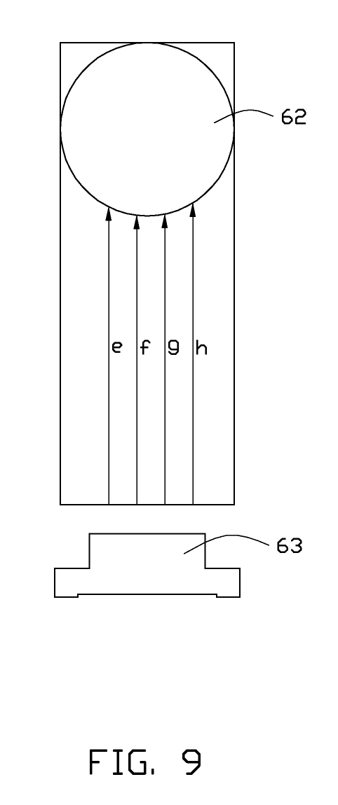

Referring to FIGS. 8-9, in use, a plurality of light beams are emitted from the light source 63, and the plurality of light beams are substantially perpendicular to the circuit board 50. The plurality of light beams 33 extends through the bottom surface 311 and emits to the curve surface 613. For example, four light beams a, b, c, and d are transmitted to the curve surface 613. When the four light beams e, f, g, and h are transmitted to the curve surface 613, the light beam e is transmitted to the arcuate concave surface 6133, and returned to the light source 63. The light beams f, g, and h are transmitted to the arcuate convex surface 6131, and then diffused to the indicator-lamp head 62. Therefore, an uniform light can be shown by the indicator-lamp head 62. In one embodiment, the light beams f, g, and h are reflected one time with the arcuate convex surface 6131, and reached to the indicator-lamp head 62.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
an enclosure comprising a bottom plate and a side plate connected to the bottom plate; a circuit board attached to the bottom plate; and
a light-guide structure comprising a light source, an indicator-lamp head, and a light-guide post located between the light source and the indicator-lamp head; the light source being electronically connected to the circuit board and configured to emit a plurality of light beams substantially perpendicular to the circuit board, and the indicator-lamp head being attached to the side plate; the light-guide post comprising a curve surface adjacent to the indicator-lamp head; the curve surface comprising an arcuate convex surface towards the indicator-lamp head;
wherein the arcuate convex surface is configured to reflect the plurality of light beams and to transmit the plurality of light beams into a plurality of emanative lights towards the indicator-lamp head.

2. The electronic device of claim 1, wherein the curve surface further comprises an arcuate concave surface connected to the arcuate convex surface, and the arcuate concave surface is configured to reflect the plurality of light beams back to the light source.

3. The electronic device of claim 2, wherein the side plate is arcuate.

4. The electronic device of claim 2, wherein the indicator-lamp head and the light source are arranged along a line that not perpendicular to a plane of the circuit board.

5. The electronic device of claim 1, wherein the light-guide post comprises a bottom surface and a first reflecting surface connected to the bottom surface, the first reflecting surface is adjacent to the light source, and an acute angle is defined between the first reflecting surface and the bottom surface.

6. The electronic device of claim 5, wherein the acute angle between the first reflecting surface and the bottom surface is 45 degrees.

7. The electronic device of claim 5, wherein the light-guide post further comprises a second reflecting surface, and the second reflecting surface is configured to receive a plurality of light beams from the first reflecting surface.

8. The electronic device of claim 7, wherein the light-guide post further comprises a first connecting surface connected to the first reflecting surface and the second reflecting surface, and an obtuse angle is defined between the first connecting surface and the second reflecting surface.

9. The electronic device of claim 8, wherein the obtuse angle between the first connecting surface and the second reflecting surface is 135 degrees.

10. An electronic device comprising:
an enclosure comprising a bottom plate;
a circuit board attached to the bottom plate; and
a light-guide structure comprising a light source, an indicator-lamp head attached to the enclosure, and a light-guide post located between the light source and the indicator-lamp head; the light source being electronically connected to the circuit board and being configured to emit a plurality of light beams substantially perpendicular to the circuit board; the light-guide post comprising a curve surface adjacent to the indicator-lamp head; the curve surface comprising an arcuate convex surface towards the indicator-lamp head and an arcuate convex surface connected to the arcuate convex surface;
wherein the arcuate convex surface is configured to reflect the plurality of light beams and to transmit the plurality of light beams into a plurality of emanative light beams towards the indicator-lamp head.

11. The electronic device of claim 10, wherein the indicator-lamp head and the light source are arranged along a line not perpendicular to a plane of the circuit board.

12. The electronic device of claim 10, wherein the light-guide post comprises a bottom surface and a first reflecting surface connected to the bottom surface, the first reflecting surface is adjacent to the light source, and an acute angle is defined between the first reflecting surface and the bottom surface.

13. The electronic device of claim 12, wherein the acute angle between the first reflecting surface and the bottom surface is 45 degrees.

14. The electronic device of claim 12, wherein the light-guide post further comprises a second reflecting surface, and the second reflecting surface is configure to receive a plurality of light beams from the first reflecting surface.

15. The electronic device of claim 14, wherein the light-guide post further comprises a first connecting surface connected to the first reflecting surface and the second reflecting surface, and an obtuse angle is defined between the first connecting surface and the second reflecting surface.

16. The electronic device of claim 15, wherein the obtuse angle between the first connecting surface and the second reflecting surface is 135 degrees.

17. The electronic device of claim 10, wherein the enclosure further comprises a top plate and a side plate connected between the bottom plate and the top plate, and the indicator-lamp head is attached to either the side plate or the top plate.

18. The electronic device of claim 10, wherein the indicator-lamp head is either round shaped or rectangular shaped.
